(19) United States
(12) Patent Application Publication
(10) Pub. No.: US 2026/0138153 A1
(43) Pub. Date: May 21, 2026

(54) TRANSPARENT INVISIBLE MULTILAYER STRUCTURE AND PREPARATION METHOD THEREOF

(71) Applicant: Shenzhen Yimingyue Technology Co., Ltd., Shenzhen City (CN)

(72) Inventors: Shengfei Cao, Shenzhen City (CN); Zuming Cao, Shenzhen City (CN); Linhao Yao, Shenzhen City (CN)

(73) Assignee: Shenzhen Yimingyue Technology Co., Ltd., Shenzhen City (CN)

(21) Appl. No.: 19/389,208

(22) Filed: Nov. 14, 2025

(30) Foreign Application Priority Data
Nov. 15, 2024 (CN) 202411633589.9

(51) Int. Cl. B05D 5/06; B05D 3/12; B05D 7/00; B05D 7/04; B05D 7/24; B29C 43/28

(52) U.S. Cl. CPC B05D 5/06; B05D 3/12; B05D 7/04; B05D 7/24; B05D 7/56; B29C 43/28; B29K 2995/0026

(57) ABSTRACT

A transparent invisible multilayer structure and a preparation method thereof are provided. The preparation method includes: coating a layer of a transparent liquid coating onto a side of a transparent carrier film; pressing protrusions of a transfer mold against the transparent liquid coating, curing, and peeling off the transfer mold after the curing, with recesses matching the protrusions in shape formed on a resulting cured liquid coating, thereby obtaining a recessed see-through layer; printing a light shielding layer on a side of the recessed see-through layer away from the transparent carrier film, such that first through holes are provided; and printing a decorative layer on a side of the light shielding layer away from the transparent carrier film, such that second through holes are provided, and the second through holes are interconnected with the recesses via the first through holes to form light-transmitting holes respectively, thereby obtaining a multilayer structure.

### CROSS REFERENCE TO RELATED APPLICATION

This patent application claims the benefit and priority of Chinese Patent Application No. 202411633589.9 filed with the China National Intellectual Property Administration on Nov. 15, 2024, the disclosure of which is incorporated by reference herein in its entirety as part of the present application.

### TECHNICAL FIELD

The present disclosure relates to the technical field of housings, and in particular to a transparent invisible multilayer structure and a preparation method thereof.

### BACKGROUND

In many decorative and functional applications, it is necessary to allow light to pass through some areas while maintaining aesthetic patterns. For example, in smart home devices, display screens often need to be concealed within housings of the devices. The display screens are concealed and integrated with patterns of the housings when not in use, and could display information via light-transmitting areas when needed. In the design of automotive dashboards, information also needs to be displayed via light-transmitting areas on trim panels. In furniture and decorations, a light source effect is achieved via light-transmitting areas on trim panels, thus improving the added value and aesthetics of products.

In modern decorative and functional applications, a transparent invisible display panel technology gains increasing attention. In this technology, by designing light-transmitting areas on panels having decorative patterns, the panels could display screens or light sources concealed beneath the panels under specific conditions, achieving both aesthetics and functionality. Common application scenarios include the smart home devices, the automotive dashboards, home decorations, billboards, and electronic device housings. However, traditional transparent invisible panel technology often involves complex structural designs and high-cost manufacturing processes, such as laser cutting or micron-level processing technologies. These methods have high costs and low production efficiency, and could hardly meet requirements of a mass production.

To overcome these technical bottlenecks, researchers and engineers have explored a variety of new materials and processes. For example, the transparency of photochromic materials, electrochromic materials and thermochromic materials could be changed along with changes in a light, a voltage or a temperature, thereby enabling bottom screens to be invisible or displayed. A liquid crystal display technology and smart glass technology use electronic control to adjust the transparency of materials, providing efficient light control. In addition, a micro-louver technology and controllable light-transmitting coatings use mechanical control or electronic control to adjust the light-transmitting areas, achieving precise control of light transmission.

Although these new technologies offer a variety of methods to produce transparent invisible display panels, there are still some limitations, such as high material costs, complicated processes and limited scope of application. Therefore, the development of a simple, efficient and low-cost multilayer structure for the transparent invisible display panels and a preparation method of the multilayer structure is a key to solving this problem.

### SUMMARY

Main objects of the present disclosure are to provide a transparent invisible multilayer structure and a preparation method thereof, intending to solve the technical problems in the conventional art that a process for preparing a multilayer structure is complicated, is high in cost and low in production efficiency.

In order to achieve the above objects, the present disclosure provides a method for preparing a transparent invisible multilayer structure, including:

providing a transparent carrier film and coating a layer of a transparent liquid coating onto a side of the transparent carrier film;

providing a transfer mold with preformed protrusions, pressing the preformed protrusions of the transfer mold against the transparent liquid coating, curing the transparent liquid coating, and peeling off the transfer mold after the curing, with recesses matching the preformed protrusions in shape formed on a resulting cured liquid coating, thereby obtaining a recessed see-through layer;

printing, by a planographic printing process, a light shielding layer on a surface, excluding the recesses, of a side of the recessed see-through layer away from the transparent carrier film, such that first through holes interconnected with the recesses respectively are provided at positions, corresponding to the recesses, of the light shielding layer; and

printing, by the planographic printing process, a decorative layer on a surface, excluding the first through holes, of a side of the light shielding layer away from the transparent carrier film, such that second through holes interconnected with the first through holes are provided at positions, corresponding to the first through holes, of the decorative layer, and the second through holes are interconnected with the recesses via the first through holes to form light-transmitting holes respectively, thereby obtaining a multilayer structure.

Further, in some embodiments, the step of printing, by the planographic printing process, the light shielding layer on the surface, excluding the recesses, of the side of the recessed see-through layer away from the transparent carrier film is conducted in three stages, the three stages including:

providing a printing plate with preset graphics and text information, and coating an ink onto a side of the printing plate that has the preset graphics and text information;

transferring the ink to a rubber blanket; and

covering the side of the recessed see-through layer away from the transparent carrier film with a side of the rubber blanket coated with the ink, and applying a pressure, and transferring the ink to the surface, excluding the recesses, of the recessed see-through layer from the rubber blanket to form the light shielding layer having the first through holes.

Further, in some embodiments, the step of providing the printing plate with the preset graphics and text information, and coating the ink onto the side of the printing plate that has the preset graphics and text information is conducted in three steps, the three steps including:

transferring the preset graphics and text information to the printing plate by photographic color separation or electronic color separation, where the printing plate has an oleophilic hydrophobic graphics and text area and a hydrophilic oleophobic blank area, and a first graphics and text information includes at least one selected from the group consisting of a graphic and a text;

coating the ink onto the oleophilic hydrophobic graphics and text area of the printing plate, and absorbing the ink into the oleophilic hydrophobic graphics and text area; and

wetting the hydrophilic oleophobic blank area of the printing plate with a wetting solution to form a layer of a water film in the hydrophilic oleophobic blank area.

Further, in some embodiments, the step of transferring the ink to the rubber blanket includes:

covering an ink surface of the printing plate with the rubber blanket, and transferring the ink on the printing plate to the rubber blanket from the printing plate.

Further, in some embodiments, the decorative layer includes a pattern layer and a backing layer, where the backing layer is provided on the side of the light shielding layer away from the transparent carrier film; and

the patterned layer is provided on a side of the backing layer away from the light shielding layer.

Further, in some embodiments, the step of providing the transfer mold with the preformed protrusions includes:

providing a plurality of the preformed protrusions, machining to obtain the transfer mold with the preformed protrusions in accordance with an arrangement and a size of the preformed protrusions, where the arrangement of the preformed protrusions refers to at least one selected from the group consisting of an equilateral triangular grid arrangement, a square grid arrangement, and a honeycomb grid arrangement.

Further, in some embodiments, after printing, by the planographic printing process, the decorative layer on the surface, excluding the first through holes, of the side of the light shielding layer away from the transparent carrier film, such that the second through holes interconnected with the first through holes are provided at the positions, corresponding to the first through holes, of the decorative layer, and the second through holes are interconnected with the recesses via the first through holes to form the light-transmitting holes respectively, thereby obtaining the multilayer structure, the method further includes:

providing a filling layer on a side of the decorative layer away from the transparent carrier film and within the light-transmitting holes, such that the light-transmitting holes are full of the filling layer.

Further, in some embodiments, after providing the filling layer on the side of the decorative layer away from the transparent carrier film and within the light-transmitting holes, such that the light-transmitting holes are full of the filling layer, the method further includes:

providing a bonding layer on a side of the filling layer away from the transparent carrier film; and

providing a light source for the multilayer structure on an other side of the transparent carrier film away from the bonding layer; or

providing a bonding layer on an other side of the transparent carrier film away from the filling layer; and

providing a light source for the multilayer structure on a side of the bonding layer away from the filling layer.

The present disclosure further provides a preparation method of a transparent invisible multilayer structure. The preparation method includes: providing a transparent carrier film and coating a layer of a transparent liquid coating onto a side of the transparent carrier film;

providing a transfer mold with preformed protrusions, pressing the preformed protrusions of the transfer mold against the transparent liquid coating, curing the transparent liquid coating, and peeling off the transfer mold after the curing, with recesses matching the preformed protrusions in shape formed on a resulting cured liquid coating, thereby obtaining a recessed see-through layer;

printing, by a planographic printing process, a decorative layer on a surface, excluding the recesses, of a side of the recessed see-through layer away from the transparent carrier film, such that second through holes interconnected with the recesses respectively are provided at positions, corresponding to the recesses, of the decorative layer; and

printing, by the planographic printing process, a light shielding layer on a surface, excluding the second through holes, of a side of the decorative layer away from the transparent carrier film, such that first through holes interconnected with the second through holes are provided at positions, corresponding to the second through holes, of the light shielding layer, and the first through holes are interconnected with the recesses via the second through holes to form light-transmitting holes respectively, thereby obtaining a multilayer structure.

Further, in some embodiments, the decorative layer includes a pattern layer and a backing layer, where the pattern layer is provided on the side of the recessed see-through layer away from the transparent carrier film; and

the backing layer is provided on a side of the pattern layer away from the recessed see-through layer.

Further, in some embodiments, after printing, by the planographic printing process, the light shielding layer on the surface, excluding the second through holes, of the side of the decorative layer away from the transparent carrier film, such that the first through holes interconnected with the second through holes are provided at the positions, corresponding to the second through holes, of the light shielding layer, and the first through holes are interconnected with the recesses via the second through holes to form the light-transmitting holes respectively, thereby obtaining the multilayer structure, the preparation method further includes:

providing a filling layer on a side of the light shielding layer away from the transparent carrier film and within the light-transmitting holes, such that the light-transmitting holes are full of the filling layer.

Further, in some embodiments, after providing the filling layer on the side of the light shielding layer away from the transparent carrier film and within the light-transmitting holes, such that the light-transmitting holes are full of the filling layer, the preparation method further includes:

providing a bonding layer on an other side of the transparent carrier film away from the filling layer; and

providing a light source for the multilayer structure on a side of the filling layer away from the bonding layer.

Further, in some embodiments, after providing the filling layer on the side of the light shielding layer away from the transparent carrier film and within the light-transmitting holes, such that the light-transmitting holes are full of the filling layer, the preparation method further includes:

providing a surface treatment layer on an other side of the transparent carrier film away from the filling layer;

providing a bonding layer on a side of the filling layer away from the surface treatment layer; and

providing a light source for the multilayer structure on the side of the bonding layer away from the filling layer.

The present disclosure further provides a transparent invisible multilayer structure, prepared by the method.

The present disclosure further provides a transparent invisible multilayer structure, prepared by the preparation method.

In the technical solutions of the present disclosure, a layer of transparent liquid coating is coated onto a transparent carrier film, protrusions of a transfer mold having preformed protrusions arranged in array are pressed against the transparent liquid coating, the transparent liquid coating is then cured, recesses with the same arrangement, size and depth as the protrusions are formed on a cured liquid coating after the transfer mold is peeled off, so that a recessed see-through layer is obtained, where the recessed see-through layer with the recesses has uneven surface; moreover, a light shielding layer is printed on a surface of the recessed see-through layer that has the recesses by a planographic printing process; during printing, an ink of the light shielding layer comes into contact with a flat surface of the recessed see-through layer but does not come into contact with the recesses, a pressure is applied to the flat surface only, and the recesses are not subjected to any acting force, so that the light shielding layer is printed on the flat surface of the recessed see-through layer but the recesses are not filled or covered with the ink, where first through holes interconnected with the recesses are formed at positions, corresponding to the recesses, of the light shielding layer; based on the same working principle, a decorative layer is printed on the light shielding layer, second through holes interconnected with the first through holes are formed at positions, corresponding to the first through holes, of the decorative layer, and the recesses, the first through holes and the second through holes form light-transmitting holes respectively, so that a multilayer structure is obtained. Accordingly, a process for preparing a transparent invisible multilayer structure is simple, low-cost and efficient, and the multilayer structure has a good light transmitting effect and a good display effect.

### BRIEF DESCRIPTION OF THE DRAWINGS

One or more embodiments are illustrated by way of examples through drawings corresponding thereto, and these examples do not constitute a limitation on the embodiments. Components with the same reference signs in the drawings are represented as similar components. Unless otherwise specified, figures in the drawings do not constitute scale restrictions.

FIG. 1 shows a schematic diagram of a first example of a method for preparing a transparent invisible multilayer structure in the embodiments of the present disclosure;

FIG. 2 shows a schematic diagram of a second example of a method for preparing a transparent invisible multilayer structure in the embodiments of the present disclosure;

FIG. 3 shows a schematic structural diagram of the transparent invisible multilayer structure according to the second example of the present disclosure;

FIG. 4 shows a schematic structural diagram of the transparent invisible multilayer structure according to the second example of the present disclosure;

FIG. 5 shows a schematic diagram of a third example of a preparation method of a transparent invisible multilayer structure in the embodiments of the present disclosure;

FIG. 6 shows a schematic structural diagram of the transparent invisible multilayer structure according to the third example of the present disclosure; and

FIG. 7 shows a schematic structural diagram of a transparent invisible multilayer structure according to a fourth example of the present disclosure.

### DETAILED DESCRIPTION OF THE EMBODIMENTS

For ease of understanding the present disclosure, the present disclosure is described in further details below with reference to drawings and embodiments. It should be noted that when an element is described to be “fixed” to another element, it may be directly on the another element or there may also be one or more elements therebetween. When an element is described to be “connected” to another element, it may be directly connected to the another element or there may also be one or more elements therebetween. Terms “vertical”, “horizontal”, “left”, “right”, “inner”, “outer” and similar expressions are used in the specification for illustrative purposes only. In the description of the present disclosure, terms “first” and “second” are used for descriptive purposes only, and could not be construed as indicating relative importance or implicitly indicating a number of technical features indicated. Thus, unless otherwise stated, features defined by “first” and “second” may explicitly or implicitly include one or more of the features; and “a plurality of” means two or more. Term “comprise/include” and any variations thereof means non-exclusive inclusion, which may have or be added with one or more other features, integers, steps, operations, units, components and/or combinations thereof.

In addition, terms “mount”, “connected”, and “connect” should be interpreted in a broad sense unless explicitly defined and limited otherwise. For example, they may be a fixed connection, a detachable connection, or an integral connection; may be a mechanical connection or an electrical connection; or may be a direct connection, an indirect connection by means of an intermediary, or may be an internal communication between two elements. All technical and scientific terms used in the specification should have the same meanings as commonly understood by those skilled in the art to which the present disclosure belongs. The terms used in the specification of the present disclosure are merely for a purpose of describing specific embodiments, but are not used to limit the present disclosure. A term “and/or” used in the specification includes any or all combinations of one or more of relevant listed items.

In addition, the technical features involved in the embodiments of the present disclosure described below could be combined with each other as long as they do not conflict with each other.

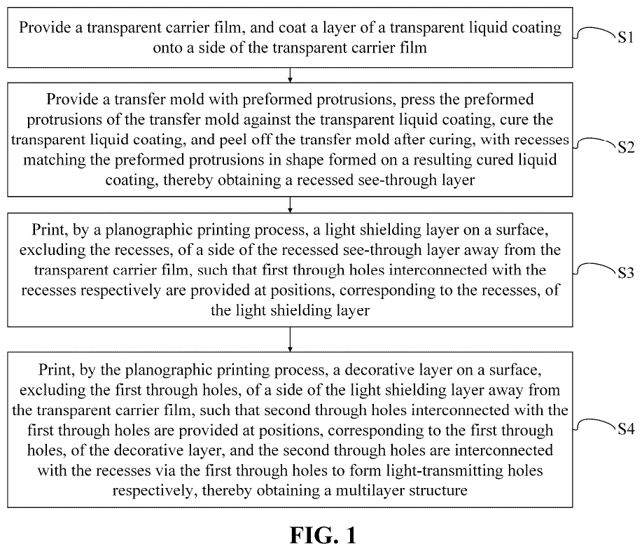

For ease of understanding, specific processes of the embodiments of the present disclosure are described below. Referring to FIG. 1, a first example of a method for preparing a transparent invisible multilayer structure in embodiments of the present disclosure was performed as follows.

S1: A transparent carrier film was provided, and a layer of a transparent liquid was coated onto a side of the transparent carrier film.

In this step, the transparent carrier film is a high-transparency decorative thin-film material, which may be polyterephthalate plastics (PET) or polycarbonate (PC). The transparent carrier film is used for supporting and carrying the transparent liquid coating. A transparent carrier film was prepared first and then the layer of the transparent liquid coating was coated onto a surface of the transparent carrier film. Of course, a release technology may also be applied, in which the transparent liquid coating is applied on a release film, the release film is peeled off after a multilayer structure is formed through the subsequent processes, and then the multilayer structure with the release film peeled off is transferred onto a metal, a plastic, a glass, a glass fiber, a carbon fiber, an aramid fiber, a bamboo fiber, a wood, a leather, a PU leather or an organic silicon leather by a transfer process, so that the multilayer structure is adaptable to a wide range of substrate materials.

S2: A transfer mold with preformed protrusions was provided, the preformed protrusions of the transfer mold were pressed against the transparent liquid coating, the transparent liquid coating was cured, and after curing, the transfer mold was peeled off, with recesses matching the preformed protrusions in shape formed on a resulting cured liquid coating, thereby obtaining a recessed see-through layer.

In this step, an arrangement, a shape, a size and a depth of protrusions of the transfer mold can be designed in one to one correspondence based on an actual display effect. It is determined whether the transparent invisible multilayer structure is mounted on a screen or an LED light source, and then the specific arrangement, the size, the shape and the depth of the protrusions are determined based on a final display effect. After determination, the protrusions were formed by UV lithography or machining technology to form the transfer mold with the protrusions, and the protrusions of the transfer mold were pressed against the transparent liquid coating. Since the transparent liquid coating is in a liquid state, it is easy to press the transfer mold into the transparent liquid coating. After the transfer mold was pressed into the transparent liquid coating by a preset depth, the transparent liquid coating was cured by UV baking. The transfer mold was peeled off from the transparent liquid coating after the liquid coating was cured, and the recesses were formed on the cured liquid coating, where an arrangement, a shape, a size and a depth of the recesses all match those of the protrusions, i.e., the recesses and the protrusions were male and female structure mating with each other. In this way, the recessed see-through layer was obtained. By the way of transferring the protrusions of the transfer mold with the arrangement, the shape, the size and the depth onto the recessed see-through layer, the recessed see-through layer has the recesses with the same arrangement, the same shape, the same size and the same depth. The process is simple and efficient. Moreover, it is possible to optimize a design of the protrusions according to actual situations, thus achieving a better display effect.

S3: A light shielding layer, by a planographic printing process, was printed on a surface, excluding the recesses, of a side of the recessed see-through layer away from the transparent carrier film, such that first through holes interconnected with the recesses respectively were provided at positions, corresponding to the recesses, of the light shielding layer.

In this step, the principle of planographic printing is to establish an oleophilic hydrophobic graphics and text area and a hydrophilic oleophobic blank area on a surface of a printing plate based on the property of oil repelling water. Printing is performed based on the principle of oil repelling water, and the planographic printing process has advantages such as high printing speed, high printing quality, and low printing cost. The light shielding layer shields light, which may refer to a black ink or a white ink printed multiple times and stacked to a certain thickness, further reducing transmittance. Because the planographic printing process refers to transferring an ink from a rubber blanket to the surface of the recessed see-through layer away from the transparent carrier film by pressure, after the surface of the recessed see-through layer away from the transparent carrier film comes into contact with the rubber blanket, such that a flat part of the surface of the recessed see-through layer having the recesses is subjected to contact and pressure after the contact with the rubber blanket, while the recesses are not subjected to contact or pressure, achieving that the recesses are not covered or full of the ink, while the positions, corresponding to the recesses, of the light shielding layer, are not covered with the ink, thereby forming the first through holes interconnected with the recesses respectively.

Specifically, the light shielding layer was prepared by the following 6 steps of the planographic printing process: first, the printing plate was made, and preset graphics and text information was transferred to the printing plate by photographic color separation, electronic color separation, and other technologies, where the printing plate was usually made of materials such as an aluminum plate and a zinc plate, of which a surface was treated to form an oleophilic hydrophobic graphics and text area and a hydrophilic oleophobic blank area; inking: the ink was coated onto the oleophilic hydrophobic graphics and text area of the printing plate, and the ink was absorbed into the oleophilic hydrophobic graphics and text area; wetting: the hydrophilic oleophobic blank area of the printing plate was wetted with a wetting solution to form a layer of water film in the hydrophilic oleophobic blank area; transferring: the printing plate was covered with the rubber blanket to allow contact between the rubber blanket and the printing plate, the ink was transferred from the printing plate to the rubber blanket; printing: the side of the rubber blanket having the ink was contacted with the surface of the recessed see-through layer away from the transparent carrier film, and the ink was transferred from the rubber blanket to the surface of the recessed see-through layer under pressure, to complete graphics and text printing on the light shielding layer; drying: the ink on the recessed see-through layer was dried such that the ink was fixed onto the recessed see-through layer to form the light shielding layer. The light shielding layer is printed by the planographic printing process, which not only achieves quick printing and improves production efficiency but also improves printing quality and reduces printing costs.

Herein, a distance between two adjacent recesses ranges from 0.05 mm to 0.2 mm.

S4: A decorative layer, by the planographic printing process, was printed on a surface, excluding the first through holes, of a side of the light shielding layer away from the transparent carrier film, such that second through holes interconnected with the first through holes were provided at positions, corresponding to the first through holes, of the decorative layer, and the second through holes were interconnected with the recesses via the first through holes to form light-transmitting holes respectively, thereby obtaining a multilayer structure.

In this step, the decorative layer was prepared by the following 6 steps of the planographic printing process: first, a printing plate was made, and preset graphics and text information was transferred to the printing plate by photographic color separation, electronic color separation, and other technologies, where the printing plate was usually made of materials such as an aluminum plate and a zinc plate, of which a surface was treated to form an oleophilic hydrophobic graphics and text area and a hydrophilic oleophobic blank area; inking: an ink was coated onto the oleophilic hydrophobic graphics and text area of the printing plate, and the ink was absorbed into the oleophilic hydrophobic graphics and text area; wetting: the hydrophilic oleophobic blank area of the printing plate was wetted with a wetting solution to form a layer of water film in the hydrophilic oleophobic blank area; transferring: the printing plate was covered with a rubber blanket to allow contact between the rubber blanket and the printing plate, the ink was transferred from the printing plate to the rubber blanket; printing: the side of the rubber blanket having the ink was contacted with a surface of the light shielding layer away from the transparent carrier film, and the ink was transferred from the rubber blanket to the surface of the light shielding layer under pressure, to complete graphics and text printing on the decorative layer; drying: the ink on the light shielding layer was dried such that the ink was fixed onto the light shielding layer to form the decorative layer.

Since the positions, corresponding to the first through holes of the light shielding layer, of the decorative layer are recess areas, during ink transfer printing, the recess areas do not come into contact with the ink and are not subjected to acting force, the positions, corresponding to the first through holes, of the decorative layer are not covered with the ink, and accordingly the second through holes interconnected with the first through holes are formed, the recesses, the first through holes and the second through holes are interconnected to form light-transmitting holes respectively. In this way, when a power supply is turned on, light is passed through the light-transmitting holes. The decorative layer is printed by the planographic printing process, which not only achieves quick printing and improves production efficiency but also improves printing quality and reduces printing costs.

Herein, the light-transmitting holes have a diameter in a range of 0.01 mm to 0.1 mm, so that the light-transmitting holes are small. In the absence of a light source, light irradiates to a light-tight area of a pattern on the decorative layer, and is reflected to human eyes. However, due to the small light-transmitting holes which cannot be seen with the naked eye, the complete pattern on the decorative layer is visible. In the presence of a light source, light is transmitted through the light-transmitting holes, the light source or the content displayed on the screen can be seen, but the pattern of the decorative layer is invisible due to the light tight, thereby achieving a transparent invisible effect.

In this example, the protrusions of the transfer mold with the arrangement, the shape, the size and the depth are transferred onto the recessed see-through layer such that the recessed see-through layer has the recesses with the same arrangement, the same shape, the same size and the same depth. The process is simple, low-cost and efficient. Moreover, it is possible to optimize the design of the protrusions according to the actual situations, so that the recesses have a better light transmitting effect, achieving the better display effect. The light shielding layer and the decorative layer are sequentially provided on the recessed see-through layer by the planographic printing process. Since the ink does not come into contact with the recesses during printing, the recesses are not covered or full of the ink; the first through holes interconnected with the recesses respectively are formed at the positions, corresponding to the recesses, of the light shielding layer, while the second through holes interconnected with the first through holes respectively are formed at the positions, corresponding to the first through holes, of the decorative layer, to form the light-transmitting holes. When the light source for the multilayer structure is turned on, the light source or the content displayed on the screen can be seen; when the light source is turned off, the light-transmitting holes are opaque and the pattern on the decorative layer is displayed at this point. Moreover, the planographic printing process is low-cost, efficient and simple.

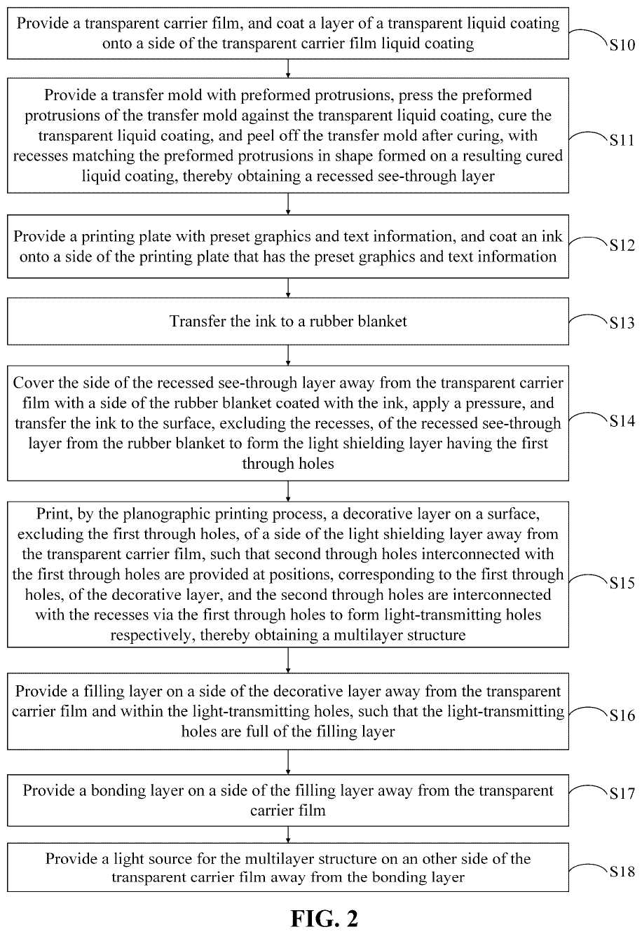

Referring to FIG. 2, further disclosed in the embodiments of the present disclosure is a second example of the method for preparing the transparent invisible multilayer structure.

S10: A transparent carrier film was provided, and a layer of a transparent liquid coating onto was coated onto a side of the transparent carrier film.

The description of the above step S10 refers to the step S1 in the first example, which will not be described in detail here.

S11: A transfer mold with preformed protrusions was provided, the preformed protrusions of the transfer mold were pressed against the transparent liquid coating, the transparent liquid coating was cured, and after curing the transfer mold was peeled off, with recesses matching the preformed protrusions in shape formed on a resulting cured liquid coating, thereby obtaining a recessed see-through layer.

The description of the above step S11 refers to the step S2 in the first example, which will not be described in detail here.

The step S11 of providing the transfer mold with the preformed protrusions was performed as follows.

A plurality of the preformed protrusions were provided, and machined to obtain the transfer mold with the preformed protrusions in accordance with an arrangement and a size of the preformed protrusions, where the arrangement of the preformed protrusions refers to at least one selected from the group consisting of an equilateral triangular grid arrangement, a square grid arrangement, and a honeycomb grid arrangement.

In this step, a setting number of the preformed protrusions was determined according to the demand for light transmission of a multilayer structure, and a specific arrangement such as an equilateral triangular grid arrangement, a square grid arrangement, and a honeycomb grid arrangement, a specific value of a size, a specific shape, and a specific value of a depth were determined based on a light source for the multilayer structure, enabling prepared recesses to have a light transmitting effect most suitable for the light source, thereby achieving the best display effect. The preformed protrusions can be prepared by UV lithography or machining. In addition, since the recesses are formed on the recessed see-through layer by transfer printing, the arrangement, the size, the shape and the depth of the preformed protrusions determine the an arrangement, a size, a shape and a depth of the recesses. Here, the light source for the multilayer structure may be a screen or an LED light source.

Since an arrangement of light-transmitting holes is designed in combination with an arrangement of the light source for the multilayer structure to reduce the generation of moires or interferences and to improve a light effect or a screen display effect, the light-transmitting holes can be arranged in accordance with an actual arrangement of the light source for the multilayer structure in an actual production process, which is not limited to the equilateral triangular grid arrangement, the square grid arrangement or the honeycomb grid arrangement.

Moreover, the overall light transmission can be changed by adjusting an arrangement and a size of a light-transmitting hole array within a certain range according to needs, or inner surfaces of recesses of the light-transmitting holes can be added with optical textures, to further change the light transmitting effect, so that the light transmitting effect of the light-transmitting holes of the present disclosure is better than that of light-transmitting holes machined by punching or mesh processing in a conventional art.

When the light source for the multilayer structure refers to the LED light source, the arrangement, the size and the depth of the recessed may be designed based on principles of a light guide plate, enabling uniform diffusion of a light while achieving functions of the light guide plate.

Specifically, the light guide plate is an optical-grade acrylic plate/PC plate, and light guide spots are printed on a bottom surface of the optical-grade acrylic plate using a high-tech material with very high reflectivity and non-light absorption through laser engraving, V-shaped cross-grid engraving, and UV screen printing technologies. Its principle mainly refers to, based on the principle of light total reflection and light scattering law at an interface of a transparent plate, deflecting light incoming from an end face by 90° and then emitting the light from a front side, thereby achieving a light guide function. When light irradiates to the various light guide spots, a reflected light diffuses in various angles and then breaks a reflection condition to be emitted from a front side of the light guide plate. The light guide plate achieves uniform light emission through the light guide spots with different densities and sizes. A reflector plate is used to reflect light exposed from the bottom surface back into the light guide plate, thereby improving the efficiency of light utilization. Under the same area luminance, a luminous efficiency is high and a power consumption is low. Since the recesses are designed with optical textures for a design of a recess array, an incident light diffuses in various angles after passing through textures within recess points, making the light softer and more uniform.

S12: A printing plate with preset graphics and text information was provided, and an ink was coated onto a side of the printing plate that has the preset graphics and text information.

The step S12 was performed as follows.

(1) The preset graphics and text information was transferred to the printing plate by photographic color separation or electronic color separation, where the printing plate had an oleophilic hydrophobic graphics and text area and a hydrophilic oleophobic blank area, and a first graphics and text information consisted of at least one selected from the group consisting of a graphic and a text.

(2) An ink was coated onto the oleophilic hydrophobic graphics and text area of the printing plate, and the ink was absorbed into the oleophilic hydrophobic graphics and text area.

(3) The hydrophilic oleophobic blank area of the printing plate was wetted with a wetting solution to form a layer of a water film in the hydrophilic oleophobic blank area.

In this step, a style of graphics to be printed was determined first, where the style of the graphics was only the graphic or a combination of the graphic and the text; and then, a designed style of the graphics was transferred to the printing plate by photographic color separation or electronic color separation, where the printing plate was usually made of materials such as an aluminum plate and a zinc plate, of which a surface was treated to form the oleophilic hydrophobic graphics and text area and the hydrophilic oleophobic blank area. The ink was then coated onto the oleophilic hydrophobic graphics and text area of the printing plate, and the ink was absorbed to the oleophilic hydrophobic graphics and text area. The hydrophilic oleophobic blank area of the printing plate was wetted by the wetting solution to form the layer of the water film in the hydrophilic oleophobic blank area. After that, printing was performed based on the principle of oil repelling water.

S13: The ink was transferred to a rubber blanket.

In this step, the ink was transferred from the printing plate to the rubber blanket through contact between the rubber blanket and the ink on the printing plate. The operation is simple, with low cost.

The step S13 was performed as follows.

An ink surface of the printing plate was covered with the rubber blanket, and the ink on the printing plate was transferred to the rubber blanket from the printing plate.

In this step, the ink surface of the printing plate was covered with the rubber blanket, and the rubber blanket was contacted with the ink on the printing plate, such that the ink on the printing plate was transferred from the printing plate to the rubber blanket. The operation is simple, with low cost.

S14: The side of the recessed see-through layer away from the transparent carrier film was covered with a side of the rubber blanket coated with the ink, a pressure was applied, and the ink was transferred to a surface, excluding the recesses, of the recessed see-through layer from the rubber blanket to form a light shielding layer having first through holes.

In this step, the side of the rubber blanket that had the ink covered a surface of the recessed see-through layer away from the transparent carrier film. Since the surface of the recessed see-through layer away from the transparent carrier film is a surface of the recessed see-through layer that had the recesses, the ink came into direct contact with a flat surface of the surface of the recessed see-through layer that had the recesses but did not come into contact with the recesses. Since the recesses were lower than the flat surface, when the rubber blanket was pressurized, the pressure acted on the flat surface of the recessed see-through layer, and the ink was transferred from the rubber blanket to the flat surface of the recessed see-through layer to form the light shielding layer. Since the recesses were lower than the flat surface, the pressure did not act on the recesses, the recesses were not filled or covered with the ink, and accordingly the first through holes were formed at positions, corresponding to the recesses, of the light shielding layer. As planographic printing refers to transferring an ink from a rubber blanket to a printed sheet by a pressure after contact between the printed sheet and the rubber blanket, by providing recesses on a printing surface while preventing the recesses being full of the ink. A method of forming the light-transmitting holes has simple operation and low cost, and could improve production efficiency.

S15: A decorative layer, by a planographic printing process, was printed on a surface, excluding the first through holes, of a side of the light shielding layer away from the transparent carrier film, such that second through holes interconnected with the first through holes were provided at positions, corresponding to the first through holes, of the decorative layer, and the second through holes were interconnected with the recesses via the first through holes to form light-transmitting holes respectively.

The description of the above step S15 refers to the step S4 in the first example, which will not be described in detail here.

The step S15 was performed as follows.

The decorative layer consisted of a pattern layer and a backing layer, where the backing layer was provided on the side of the light shielding layer away from the transparent carrier film.

The patterned layer was provided on a side of the backing layer away from the light shielding layer.

In this step, since the pattern layer printed by planographic printing has a transparent color, a white backing layer needs to be printed to enhance and reflect the color of the pattern layer to make the pattern display clearer. The decorative layer consisted of a pattern layer and a backing layer, where the backing layer was printed on a surface of the light shielding layer away from the transparent carrier film by the planographic printing process. The backing layer is used to enhance and reflect the color of the pattern layer. The pattern layer was printed on a surface of the backing layer away from the light shielding layer by the planographic printing process. The pattern layer makes the appearance of the multilayer structure richer and more gorgeous.

S16: A filling layer was provided on a side of the decorative layer away from the transparent carrier film and within the light-transmitting holes, such that the light-transmitting holes were full of the filling layer.

In this step, the filling layer was formed on a surface of the decorative layer away from the transparent carrier film and within the light-transmitting holes by transfer printing or curtain coating, and was made of a transparent material or a semi-transparent material, such as an UV glue, an epoxy resin, polyurethane or acrylate. After filling, it not only makes the multilayer structure flatter and more beautiful, but also protects the decorative layer from damage. The filling layer may be provided or not provided according to actual situations.

S17: A bonding layer was provided on a side of the filling layer away from the transparent carrier film.

In this step, the bonding layer was a back adhesive, which was the UV glue or an adhesive transparent material. The back adhesive was applied to a surface of the filling layer away from the transparent carrier film. The back adhesive is used to bond a light source for the multilayer structure, and a glass or a transparent injection-molded part.

S18: The light source for the multilayer structure was provided on an other side of the transparent carrier film away from the bonding layer.

In this step, the glass or the transparent injection-molded part was bonded to the bonding layer, and then the light source for the multilayer structure was provided on the side of the transparent carrier film away from the bonding layer, so that the multilayer structure could emit light. The light is emitted through the light-transmitting holes, enabling user to see the light source or a content displayed on a screen. The light source for the multilayer structure may be provided on the multilayer structure by other means in addition to being bonded on the multilayer structure via a bonding layer, which does not necessarily have to be bonded via the bonding layer. For example, when a transparent frame is affixed on a side of the bonding layer away from the transparent carrier film, the transparent frame and the light source for the multilayer structure have an assembling relationship. At this point, there is no need to provide the bonding layer between the light source for the multilayer structure and the transparent carrier film.

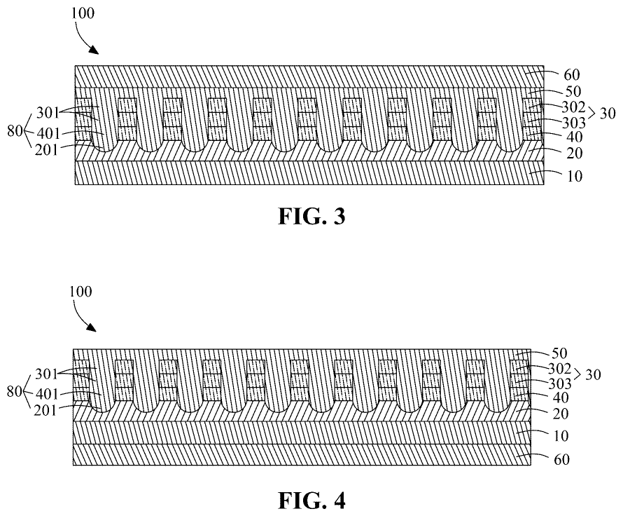

As shown in FIG. 3, FIG. 3 shows a multilayer structure 100 prepared by the method according to this example. Specifically, the multilayer structure 100 includes a transparent carrier film 10, a recessed see-through layer 20, a light shielding layer 40, a backing layer 303 and a pattern layer 302 stacked from bottom to top sequentially; the recessed see-through layer 20 is provided with a plurality of recesses 201 arranged in array, first through holes 401 interconnected with the recesses 201 respectively are provided at positions, corresponding to the recesses 201, of the light shielding layer 40, second through holes 301 interconnected with the first through holes 401 respectively are provided at positions, corresponding to the first through holes 401, of both the backing layer 303 and the pattern layer 302, and the recesses 201, the first through holes 401 and the second through holes 301 are interconnected sequentially to form light-transmitting holes 80 respectively. The multilayer structure 100 further includes a filling layer 50, a bonding layer 60, a light source for the multilayer structure, and a glass or a transparent injection-molded part; the filling layer 50 is provided on a side of the pattern layer 302 away from the transparent carrier film 10, and the light-transmitting holes 80 are filled with the filling layer 50; the bonding layer 60 is provided on a side of the filling layer 50 away from the transparent carrier film 10; the glass or the transparent injection-molded part is provided on a side of the bonding layer away from the transparent carrier film 10, and the light source for the multilayer structure is provided on a side of the transparent carrier film 10 away from the bonding layer, where the backing layer 303 and the pattern layer 302 are combined to form a decorative layer 30. The multilayer structure 100 in this example may choose to be not full of the filling layer 50 according to actual situations. Because the light-transmitting holes 80 have a small diameter and could not be seen by human eyes, the bonding layer 60 could also be affixed without filling to form the filling layer 50.

In another example, as shown in FIG. 4, the step S17 may be set as “a bonding layer was provided on an other side of the transparent carrier film away from the filling layer”; and the step S18 may be set as “a light source for the multilayer structure was provided on the side of the bonding layer away from the filling layer”.

In this step, the bonding layer was a back adhesive, which was the UV glue or an adhesive transparent material. The bonding layer was bonded to a surface of the transparent carrier film away from the filling layer, and the light source for the multilayer structure was bonded to the bonding layer, so that the multilayer structure could emit light. The light is emitted through the light-transmitting holes, enabling user to see the light source or a content displayed on a screen.

FIG. 4 shows a multilayer structure 100 prepared by the method according to this example. Specifically, the multilayer structure 100 includes a light source for the multilayer structure, a back adhesive, a transparent carrier film 10, a recessed see-through layer 20, a light shielding layer 40, a backing layer 303 and a pattern layer 302 stacked from bottom to top sequentially; the recessed see-through layer 20 is provided with a plurality of recesses 201 arranged in array, first through holes 401 interconnected with the recesses 201 respectively are provided at positions, corresponding to the recesses 201, of the light shielding layer 40, second through holes 301 interconnected with the first through holes 401 respectively are provided at positions, corresponding to the first through holes 401, of both the backing layer 303 and the pattern layer 302, and the recesses 201, the first through holes 401 and the second through holes 301 are interconnected sequentially to form light-transmitting holes 80 respectively. The multilayer structure 100 further includes a filling layer 50; the filling layer 50 is provided on a side of the pattern layer 302 away from the transparent carrier film 10, and the light-transmitting holes 80 are filled with the filling layer 50, where the backing layer 303 and the pattern layer 302 are combined to form a decorative layer 30. The multilayer structure in this example may choose to be not filled with the filling layer according to actual situations. Because the light-transmitting holes have a small diameter and could not be seen by human eyes, the bonding layer could also be affixed without filling to form the filling layer.

In this example, the protrusions of the transfer mold with the arrangement, the shape, the size and the depth are transferred onto the recessed see-through layer such that the recessed see-through layer has the recesses with the same arrangement, the same shape, the same size and the same depth. The process is simple, low-cost and efficient. Moreover, it is possible to optimize the design of the protrusions according to the actual situations, so that the recesses have a better light transmitting effect, achieving a better display effect. The light shielding layer and the decorative layer are sequentially provided on the recessed see-through layer by the planographic printing process. Since the ink does not come into contact with the recesses during printing, the recesses are not covered or filled with the ink; the first through holes interconnected with the recesses respectively are formed at the positions, corresponding to the recesses, of the light shielding layer, while the second through holes interconnected with the first through holes respectively are formed at the positions, corresponding to the first through holes, of the decorative layer, to form the light-transmitting holes. When the light source for the multilayer structure is turned on, the light source or the content displayed on the screen can be seen; when the light source is turned off, the light-transmitting holes are opaque and the pattern on the decorative layer is displayed at this point. Moreover, the planographic printing process is low-cost, efficient and simple.

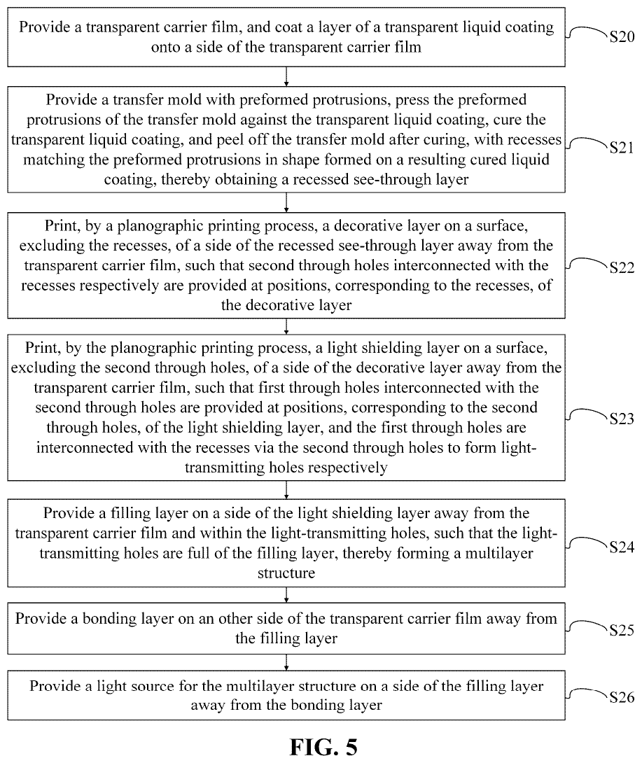

Referring to FIG. 5, further disclosed in the embodiments of the present disclosure is a third example of the preparation method of a transparent invisible multilayer structure.

S20: A transparent carrier film was provided, and a layer of a transparent liquid was coated onto a side of the transparent carrier film.

The description of the above step S20 refers to the step S1 in the first example, which will not be described in detail here.

S21: A transfer mold with preformed protrusions was provided, the preformed protrusions of the transfer mold were pressed against the transparent liquid coating, the transparent liquid coating was cured, and after curing the transfer mold was peeled off, with recesses matching the preformed protrusions in shape formed on a resulting cured liquid coating, thereby obtaining a recessed see-through layer.

The description of the above step S21 refers to the step S2 in the first example, which will not be described in detail here.

S22: A decorative layer, by a planographic printing process, was printed on a surface, excluding the recesses, of a side of the recessed see-through layer away from the transparent carrier film, such that second through holes interconnected with the recesses respectively were provided at positions, corresponding to the recesses, of the decorative layer.

In this step, the decorative layer was prepared by the following 6 steps of the planographic printing process: first, a printing plate was made, and preset graphics and text information was transferred to the printing plate by photographic color separation, electronic color separation, and other technologies, where the printing plate was usually made of materials such as an aluminum plate and a zinc plate, of which a surface was treated to form an oleophilic hydrophobic graphics and text area and a hydrophilic oleophobic blank area; inking: an ink was coated onto the oleophilic hydrophobic graphics and text area of the printing plate, and the ink was absorbed into the oleophilic hydrophobic graphics and text area; wetting: the hydrophilic oleophobic blank area of the printing plate was wetted with a wetting solution to form a layer of water film in the hydrophilic oleophobic blank area; transferring: the printing plate was covered with a rubber blanket to allow contact between the rubber blanket and the printing plate, the ink was transferred from the printing plate to the rubber blanket; printing: a side of the rubber blanket having the ink was contacted with the surface of the recessed see-through layer away from the transparent carrier film, and the ink was transferred from the rubber blanket to a flat surface of a recessed surface of the recessed see-through layer under pressure, to complete graphics and text printing on the decorative layer; drying: the ink on the recessed see-through layer was dried such that the ink was fixed onto the recessed see-through layer to form the decorative layer.

Since the positions, corresponding to the recesses of the recessed see-through layer, of the decorative layer are recess areas, during ink transfer printing, the recess areas do not come into contact with the ink and are not subjected to acting force, the positions, corresponding to the recesses, of the decorative layer are not covered with the ink, and accordingly the second through holes interconnected with the first through holes are formed. The decorative layer is printed by the planographic printing process, which not only achieves quick printing and improves production efficiency but also improves printing quality and reduces printing costs.

The step S22 was performed as follows.

(1) The decorative layer consisted of a pattern layer and a backing layer, where the pattern layer was provided on the side of the recessed see-through layer away from the transparent carrier film.

(2) the Backing Layer Was Provided on a Side of the Pattern Layer Away From the Recessed see-through layer.

In this step, since the pattern layer printed by planographic printing has a transparent color, a white backing layer needs to be printed to enhance and reflect the color of the pattern layer to make the pattern display clearer. The decorative layer consisted of a pattern layer and a backing layer, where the pattern layer was printed on a surface of the recessed see-through layer away from the transparent carrier film by the planographic printing process. The pattern layer makes the appearance of a multilayer structure richer and more gorgeous. The backing layer is printed on a surface of the pattern layer away from the recessed see-through layer by the planographic printing process, and the backing layer is used to enhance and reflect the color of the pattern layer.

S23: A light shielding layer, by the planographic printing process, was printed on a surface, excluding the second through holes, of a side of the decorative layer away from the transparent carrier film, such that first through holes interconnected with the second through holes were provided at positions, corresponding to the second through holes, of the light shielding layer, and the first through holes were interconnected with the recesses via the second through holes to form light-transmitting holes respectively.

In this step, the light shielding layer was prepared by the following 6 steps of the planographic printing process: first, a printing plate was made, and preset graphics and text information was transferred to the printing plate by photographic color separation, electronic color separation, and other technologies, where the printing plate was usually made of materials such as an aluminum plate and a zinc plate, of which a surface was treated to form an oleophilic hydrophobic graphics and text area and a hydrophilic oleophobic blank area; inking: the oleophilic hydrophobic graphics and text area of the printing plate was coated with an ink, and the ink was absorbed into the oleophilic hydrophobic graphics and text area; wetting: the hydrophilic oleophobic blank area of the printing plate was wetted with a wetting solution to form a layer of water film in the hydrophilic oleophobic blank area; transferring: the printing plate was covered with a rubber blanket to allow contact between the rubber blanket and the printing plate, the ink was transferred from the printing plate to the rubber blanket; printing: the side of the rubber blanket having the ink was contacted with a surface of the decorative layer away from the transparent carrier film, and the ink was transferred from the rubber blanket to the surface of the decorative layer under pressure, to complete graphics and text printing on the light shielding layer; drying: the ink on the decorative layer was dried such that the ink was fixed onto the decorative layer to form the light shielding layer. The light shielding layer is printed by the planographic printing process, which not only achieves quick printing and improves production efficiency but also improves printing quality and reduces printing costs. Since the positions, corresponding to the second through holes of the decorative layer, of the light shielding layer are recess areas, during ink transfer printing, the recess areas do not come into contact with the ink and are not subjected to acting force, the positions, corresponding to the second through holes, of the light shielding layer are not covered with the ink, and accordingly the first through holes interconnected with the second through holes are formed, and the recesses, the first through holes and the second through holes are interconnected to form light-transmitting holes respectively. In this way, when a power supply is turned on, light is allowed to pass through the light-transmitting holes.

S24: A filling layer was provided on a side of the light shielding layer away from the transparent carrier film and within the light-transmitting holes, such that the light-transmitting holes were full of the filling layer.

In this step, the description of the above step S24 refers to the step S16 in the first example, which will not be described in detail here. The filling layer may not be filled according to the actual situations. Because the light-transmitting holes have a small diameter and could not be seen by human eyes, the bonding layer may also be affixed without filling to form the filling layer.

S25: A bonding layer was provided on a side of the transparent carrier film away from the filling layer.

In this step, the bonding layer was a back adhesive. The back adhesive was applied to a surface of the transparent carrier film away from the filling layer. The back adhesive is used to bond a light source for the multilayer structure, and a glass or a transparent injection-molded part.

S26: The light source for the multilayer structure was provided on an other side of the filling layer away from the bonding layer.

In this step, the glass or the transparent injection-molded part was bonded to the bonding layer, and then the light source for the multilayer structure was provided on the side of the filling layer away from the bonding layer, so that the multilayer structure could emit light. The light is emitted through the light-transmitting holes, enabling a user to see the light source or a content displayed on a screen. The light source for the multilayer structure may be provided on the multilayer structure by other means in addition to being bonded on the multilayer structure via a bonding layer, which does not necessarily have to be bonded via the bonding layer. For example, when a transparent frame is affixed on a side of the bonding layer away from the transparent carrier film, the transparent frame and the light source for the multilayer structure have an assembling relationship. At this point, there is no need to provide the bonding layer between the light source for the multilayer structure and the transparent carrier film.

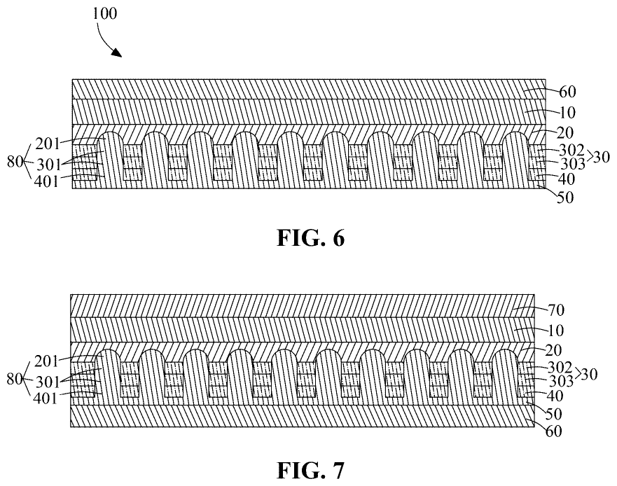

As shown in FIG. 6, FIG. 6 shows a multilayer structure 100 prepared by the preparation method according to this example. Specifically, the multilayer structure 100 includes a light source for the multilayer structure, a filling layer 50, a light shielding layer 40, a backing layer 303, a pattern layer 302, a recessed see-through layer 20, a transparent carrier film 10 and a bonding layer 60 stacked from top to bottom sequentially; the recessed see-through layer 20 is provided with a plurality of recesses 201 arranged in array, second through holes 301 interconnected with the recesses 201 respectively are provided at positions, corresponding to the recesses 201, of both the pattern layer 302 and the backing layer 303, first through holes 401 interconnected with the second through holes 301 respectively are provided at positions, corresponding to the second through holes 301, of the light shielding layer 40, and the recesses 201, the first through holes 401 and the second through holes 301 are interconnected sequentially to form light-transmitting holes 80 respectively, where the backing layer 303 and the pattern layer 302 are combined to form a decorative layer 30.

In another example, as shown in FIG. 7, the step S25 may be set as “a surface treatment layer was provided on an other side of the transparent carrier film away from the filling layer”.

In this step, the surface treatment layer was applied to a surface of the transparent carrier film away from the filling layer by curtain coating. The surface treatment layer improves the hardness and abrasion resistance of the multilayer structure, and the glass or the transparent injection-molded part could be provided on a surface of the surface treatment layer away from the transparent carrier film.

The step S26 may be set as “a bonding layer was provided on a side of the filling layer away from the surface treatment layer”. The step of “a light source for the multilayer structure was provided on the side of the bonding layer away from the filling layer” may be added after this step.

In this step, the bonding layer was bonded to a surface of the filling layer away from the surface treatment layer, and then the light source for the multilayer structure was bonded to the bonding layer, so that the multilayer structure could emit light. The light is emitted through the light-transmitting holes, enabling user to see the light source or the content displayed on the screen. When the light source for the multilayer structure is turned off, only a pattern on the decorative layer is visible. The light-transmitting holes are small and accordingly could not be observed by naked eyes, which affects aesthetics of the multilayer structure.

FIG. 7 shows a multilayer structure 100 prepared by the preparation method according to this example. Specifically, the multilayer structure 100 includes a surface treatment layer 70, a transparent carrier film 10, a recessed see-through layer 20, a pattern layer 302, a backing layer 303 and a light shielding layer 40 stacked from top to bottom sequentially; the recessed see-through layer 20 is provided with a plurality of recesses 201 arranged in array, second through holes 301 interconnected with the recesses 201 respectively are provided at positions, corresponding to the recesses 201, of both the pattern layer 302 and the backing layer 303, first through holes 401 interconnected with the second through hole 301 respectively are provided at positions, corresponding to the second through holes 301, of the light shielding layer 40, and the recesses 201, the first through holes 401 and the second through holes 301 are interconnected sequentially to form light-transmitting holes 80 respectively. The multilayer structure 100 further includes a filling layer 50, a bonding layer 60, and a light source for the multilayer structure; the filling layer 50 is provided on a side of the light shielding layer 40 away from the transparent carrier film 10, and the light-transmitting holes 80 are filled with the filling layer 50; the bonding layer 60 is provided on a side of the filling layer 50 away from the transparent carrier film 10; the light source for the multilayer structure is provided on a side of the bonding layer 60 away from the transparent carrier film 10, where the backing layer 303 and the pattern layer 302 are combined to form a decorative layer 30.

In this example, the protrusions of the transfer mold with the arrangement, the shape, the size and the depth are transferred onto the recessed see-through layer such that the recessed see-through layer has the recesses with the same arrangement, the same shape, the same size and the same depth. The process is simple, low-cost and efficient. Moreover, it is possible to optimize the design of the protrusions according to the actual situations, so that the recesses have a better light transmitting effect, achieving a better display effect. The light shielding layer and the decorative layer are sequentially provided on the recessed see-through layer by the planographic printing process. Since the ink does not come into contact with the recesses during printing, the recesses are not covered or filled with the ink; the first through holes interconnected with the recesses respectively are formed at the positions, corresponding to the recesses, of the light shielding layer, while the second through holes interconnected with the first through holes respectively are formed at the positions, corresponding to the first through holes, of the decorative layer, to form the light-transmitting holes. When the light source for the multilayer structure is turned on, the light source or the content displayed on the display screen can be seen; when the light source is turned off, the light-transmitting holes are opaque and the pattern on the decorative layer is displayed at this point. Moreover, the planographic printing process is low-cost, efficient and simple.

Further disclosed in the examples of the present disclosure is a transparent invisible multilayer structure, which was prepared by the preparation method of any of the above examples. The multilayer structure not only has a good light transmitting effect, but also has low preparation cost and high production efficiency.

The above embodiments are merely used for illustrating, rather than limiting, the technical solutions of the present disclosure. In the concept of the present disclosure, the technical features in the above embodiments or in different embodiments can also be combined, steps may be conducted in any order, and there are many other variations of different aspects of the present disclosure as described above, which are not provided in the details, for the sake of simplicity. Although the present disclosure has been described in detail with reference to the foregoing embodiments, those of ordinary skill in the art should understand that the technical solutions described in the foregoing embodiments may still be modified, or some of the technical features thereof may be equivalently substituted; and the modifications or substitutions do not make the essence of the corresponding technical solutions depart from the scope of the technical solutions in the embodiments of the present disclosure.

What is claimed is:

1. A method for preparing a transparent invisible multilayer structure, comprising the steps of:
providing a transparent carrier film, and coating a layer of a transparent liquid coating onto a side of the transparent carrier film;
providing a transfer mold with preformed protrusions, pressing the preformed protrusions of the transfer mold against the transparent liquid coating, curing the transparent liquid coating, and peeling off the transfer mold after the curing, with recesses matching the preformed protrusions in shape formed on a resulting cured liquid coating, thereby obtaining a recessed see-through layer;
printing, by a planographic printing process, a light shielding layer on a surface, excluding the recesses, of a side of the recessed see-through layer away from the transparent carrier film, such that first through holes interconnected with the recesses respectively are provided at positions, corresponding to the recesses, of the light shielding layer; and
printing, by the planographic printing process, a decorative layer on a surface, excluding the first through holes, of a side of the light shielding layer away from the transparent carrier film, such that second through holes interconnected with the first through holes are provided at positions, corresponding to the first through holes, of the decorative layer, and the second through holes are interconnected with the recesses via the first through holes to form light-transmitting holes respectively, thereby obtaining a multilayer structure.

2. The method of claim 1, wherein the printing, by the planographic printing process, the light shielding layer on the surface, excluding the recesses, of the side of the recessed see-through layer away from the transparent carrier film is conducted in three stages, the three stages comprising:
providing a printing plate with preset graphics and text information, and coating an ink onto a side of the printing plate that has the preset graphics and text information;
transferring the ink to a rubber blanket; and
covering the side of the recessed see-through layer away from the transparent carrier film with a side of the rubber blanket coated with the ink, applying a pressure, and transferring the ink to the surface, excluding the recesses, of the recessed see-through layer from the rubber blanket to form the light shielding layer having the first through holes.

3. The method of claim 2, wherein the providing the printing plate with the preset graphics and text information, and coating the ink onto the side of the printing plate that has the preset graphics and text information is conducted in three steps, the three steps comprising:
transferring the preset graphics and text information to the printing plate by photographic color separation or electronic color separation, wherein the printing plate has an oleophilic hydrophobic graphics and text area and a hydrophilic oleophobic blank area, and a first graphics and text information comprises at least one selected from the group consisting of a graphic and a text;
coating the ink onto the oleophilic hydrophobic graphics and text area of the printing plate, and absorbing the ink into the oleophilic hydrophobic graphics and text area; and
wetting the hydrophilic oleophobic blank area of the printing plate with a wetting solution to form a layer of a water film in the hydrophilic oleophobic blank area.

4. The method of claim 2, wherein the transferring the ink to the rubber blanket comprises:
covering an ink surface of the printing plate with the rubber blanket, and transferring the ink on the printing plate to the rubber blanket from the printing plate.

5. The method of claim 1, wherein the decorative layer comprises a pattern layer and a backing layer, wherein the backing layer is provided on the side of the light shielding layer away from the transparent carrier film; and
the patterned layer is provided on a side of the backing layer away from the light shielding layer.

6. The method of claim 1, wherein the providing the transfer mold with the preformed protrusions comprises:
providing a plurality of the preformed protrusions, machining to obtain the transfer mold with the preformed protrusions in accordance with an arrangement and a size of the preformed protrusions, wherein the arrangement of the preformed protrusions refers to at least one selected from the group consisting of an equilateral triangular grid arrangement, a square grid arrangement, and a honeycomb grid arrangement.

7. The method of claim 1, wherein after printing, by the planographic printing process, the decorative layer on the surface, excluding the first through holes, of the side of the light shielding layer away from the transparent carrier film, such that the second through holes interconnected with the first through holes are provided at the positions, corresponding to the first through holes, of the decorative layer, and the second through holes are interconnected with the recesses via the first through holes to form the light-transmitting holes respectively, thereby obtaining the multilayer structure, the method further comprises:
providing a filling layer on a side of the decorative layer away from the transparent carrier film and within the light-transmitting holes, such that the light-transmitting holes are full of the filling layer.

8. The method of claim 7, wherein after providing the filling layer on the side of the decorative layer away from the transparent carrier film and within the light-transmitting holes, such that the light-transmitting holes are full of the filling layer, the method further comprises:
providing a bonding layer on a side of the filling layer away from the transparent carrier film; and
providing a light source for the multilayer structure on an other side of the transparent carrier film away from the bonding layer; or
providing a bonding layer on an other side of the transparent carrier film away from the filling layer; and
providing a light source for the multilayer structure on a side of the bonding layer away from the filling layer.

9. A preparation method of a transparent invisible multilayer structure, the preparation method comprising the steps of:
providing a transparent carrier film and coating a layer of a transparent liquid coating onto a side of the transparent carrier film;
providing a transfer mold with preformed protrusions, pressing the preformed protrusions of the transfer mold against the transparent liquid coating, curing the transparent liquid coating, and peeling off the transfer mold after the curing, with recesses matching the preformed protrusions in shape formed on a resulting cured liquid coating, thereby obtaining a recessed see-through layer;
printing, by a planographic printing process, a decorative layer on a surface, excluding the recesses, of a side of the recessed see-through layer away from the transparent carrier film, such that second through holes interconnected with the recesses respectively are provided at positions, corresponding to the recesses, of the decorative layer; and
printing, by the planographic printing process, a light shielding layer on a surface, excluding the second through holes, of a side of the decorative layer away from the transparent carrier film, such that first through holes interconnected with the second through holes are provided at positions, corresponding to the second through holes, of the light shielding layer, and the first through holes are interconnected with the recesses via the second through holes to form light-transmitting holes respectively, thereby obtaining a multilayer structure.

10. The preparation method of claim 9, wherein the decorative layer comprises a pattern layer and a backing layer, wherein the pattern layer is provided on the side of the recessed see-through layer away from the transparent carrier film; and
the backing layer is provided on a side of the pattern layer away from the recessed see-through layer.

11. The preparation method of claim 9, wherein after printing, by the planographic printing process, the light shielding layer on the surface, excluding the second through holes, of the side of the decorative layer away from the transparent carrier film, such that the first through holes interconnected with the second through holes are provided at the positions, corresponding to the second through holes, of the light shielding layer, and the first through holes are interconnected with the recesses via the second through holes to form the light-transmitting holes respectively, thereby obtaining the multilayer structure, the preparation method further comprises:
providing a filling layer on a side of the light shielding layer away from the transparent carrier film and within the light-transmitting holes, such that the light-transmitting holes are full of the filling layer.

12. The preparation method of claim 11, wherein after providing the filling layer on the side of the light shielding layer away from the transparent carrier film and within the light-transmitting holes, such that the light-transmitting holes are full of the filling layer, the preparation method further comprises:
providing a bonding layer on an other side of the transparent carrier film away from the filling layer; and
providing a light source for the multilayer structure on a side of the filling layer away from the bonding layer.

13. The preparation method of claim 11, wherein after providing the filling layer on the side of the light shielding layer away from the transparent carrier film and within the light-transmitting holes, such that the light-transmitting holes are full of the filling layer, the preparation method further comprises:
providing a surface treatment layer on an other side of the transparent carrier film away from the filling layer;
providing a bonding layer on a side of the filling layer away from the surface treatment layer; and
providing a light source for the multilayer structure on the side of the bonding layer away from the filling layer.

14. A transparent invisible multilayer structure, prepared by the method of claim 1.

15. A transparent invisible multilayer structure, prepared by the preparation method of claim 9.

16. The transparent invisible multilayer structure of claim 14, wherein the printing, by the planographic printing process, the light shielding layer on the surface, excluding the recesses, of the side of the recessed see-through layer away from the transparent carrier film is conducted in three stages, the three stages comprising:
providing a printing plate with preset graphics and text information, and coating an ink onto a side of the printing plate that has the preset graphics and text information;
transferring the ink to a rubber blanket; and
covering the side of the recessed see-through layer away from the transparent carrier film with a side of the rubber blanket coated with the ink, applying a pressure, and transferring the ink to the surface, excluding the recesses, of the recessed see-through layer from the rubber blanket to form the light shielding layer having the first through holes.

17. The transparent invisible multilayer structure of claim 16, wherein the providing the printing plate with the preset graphics and text information, and coating the ink onto the side of the printing plate that has the preset graphics and text information is conducted in three steps, the three steps comprising:
transferring the preset graphics and text information to the printing plate by photographic color separation or electronic color separation, wherein the printing plate has an oleophilic hydrophobic graphics and text area and a hydrophilic oleophobic blank area, and a first graphics and text information comprises at least one selected from the group consisting of a graphic and a text;
coating the ink onto the oleophilic hydrophobic graphics and text area of the printing plate, and absorbing the ink into the oleophilic hydrophobic graphics and text area; and
wetting the hydrophilic oleophobic blank area of the printing plate with a wetting solution to form a layer of a water film in the hydrophilic oleophobic blank area.

18. The transparent invisible multilayer structure of claim 16, wherein the transferring the ink to the rubber blanket comprises:
covering an ink surface of the printing plate with the rubber blanket, and transferring the ink on the printing plate to the rubber blanket from the printing plate.

19. The transparent invisible multilayer structure of claim 15, wherein the decorative layer comprises a pattern layer and a backing layer, wherein the pattern layer is provided on the side of the recessed see-through layer away from the transparent carrier film; and
the backing layer is provided on a side of the pattern layer away from the recessed see-through layer.

20. The transparent invisible multilayer structure of claim 15, wherein after printing, by the planographic printing process, the light shielding layer on the surface, excluding the second through holes, of the side of the decorative layer away from the transparent carrier film, such that the first through holes interconnected with the second through holes are provided at the positions, corresponding to the second through holes, of the light shielding layer, and the first through holes are interconnected with the recesses via the second through holes to form the light-transmitting holes respectively, thereby obtaining the multilayer structure, the preparation method further comprises:
providing a filling layer on a side of the light shielding layer away from the transparent carrier film and within the light-transmitting holes, such that the light-transmitting holes are full of the filling layer.
